(19) United States
(12) Patent Application Publication
(10) Pub. No.: US 2020/0073933 A1
(43) Pub. Date: Mar. 5, 2020

(54) MULTI-TRIPLET EXTRACTION METHOD BASED ON ENTITY-RELATION JOINT EXTRACTION MODEL

(71) Applicant: National University of Defense Technology, Hunan (CN)

(72) Inventors: Xiang ZHAO, Hunan (CN); Zhen TAN, Hunan (CN); Aibo GUO, Hunan (CN); Bin GE, Hunan (CN); Deke GUO, Hunan (CN); Weidong XIAO, Hunan (CN); Jiuyang TANG, Hunan (CN); Xuqian HUANG, Hunan (CN)

(21) Appl. No.: 16/524,191

(22) Filed: Jul. 29, 2019

(30) Foreign Application Priority Data
Aug. 29, 2018 (CN) 201810993387.3

(51) Int. Cl. G06F 17/27; G06N 3/04; G06N 3/08

(52) U.S. Cl. CPC G06F 17/278; G06N 3/0472; G06N 3/08; G06N 3/0445

(57) ABSTRACT

The invention discloses a multi-triplets extraction method based on the entity relationship joint extraction model, comprises: performing segmentation processing on the target text, and tagging position, type and whether is involved with any relation or not of each word in the sentence; the joint extraction model of the entity relationship is established; the joint extraction model of the entity relationship is trained; the triple extraction is performed according to the joint extraction model of the entity relationship; the tri-part tagging scheme designed by the present invention is in the process of joint extraction of the entity relationship an entity that is not related to the target relationship can be excluded; the multi-triplets extraction method based on the entity relationship joint extraction model can be used to extract multiple triplets, and based on the model of the triplet extraction method of the present invention other models have stronger multi-triplets extraction capabilities.

### CROSS-REFERENCE TO RELATED APPLICATIONS

This non-provisional application claims priority under 35 U.S.C. § 119(a) on Patent Application No. 201810993387.3 filed in China on Aug. 29, 2018, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### TECHNICAL FIELD

The invention relates to the field of text processing technology, in particular to a multi-triplets extraction method based on a joint extraction model of entity relationships.

### BACKGROUND ART

Triplets extraction captures structural information, i.e., triplets of two entities with one relation, from unstructured text corpus, which is an essential and pivotal step in automatic knowledge base construction (Bollacker et al. 2008). Conventional models use a pipeline of named entity recognition (NER) (Shaalan 2014) and relation classification (RC) (Rink and Harabagiu 2010) to extract entities and relations, respectively, to produce the final triplets. Such pipelined methods may not fully capture and exploit correlations between the NER and RC tasks, being susceptible to cascading errors (Li and Ji 2014).

To overcome the shortcoming, recent research resorted to joint models, most of which are features-based structured models (Kate and Mooney 2010; Yu and Lain 2010; Chan and Roth 2011; Miwa and Sasaki 2014), which require excessive manual intervention and supervised natural language processing toolkits to construct multiplex and complicated features. Lately, several neural models have been presented to jointly extract entities and relations. Specifically, Zheng et al. utilized Bi-LSTM to learn shared hidden features, then used LSTM to extract entities, and CNN for relations (Zheng et al. 2017a). Miwa and Bansal used an end-to-end model to extract entities, and dependency tree was harnessed to determine relations (Miwa and Bansal 2016). These two models first recognize entities, and then choose a semantic relation for every possible pair of extracted entities; in this case, the RC classifier has a comparatively low precision but high recall, since it is misled by many of the pairs that fall into the other category.

Meanwhile, there are models that extract confined appearances of target relations. In particular, Zheng et al. transformed joint extraction into a tagging problem to tag entities and relations in a unified tagging scheme, and utilized an end-to-end model to solve the problem (Zheng et al. 2017b). Nevertheless, in this model each entity is constrained to be involved in only one relation in every sentence. Katiyar and Cardie also used Bi-LSTM to extract entities, and a self-attention mechanism was incorporated to extract relations (Katiyar and Cardie 2017). The model assumes that an entity could relate to only one of its preceding entities in the sentence. These two models still have not fully recognized and attached importance to the fact that there could be multiple relations associated with an entity; in this case, the RC task performs at comparatively high precision but low recall, since the scope of candidates for RC is confined.

To sum up, existing joint models either extract limited relations with unpragmatic constraints (one relation for one sentence, or relating to only one preceding entity), or simply produce too many candidates for RC (relations for all possible entity pairs). Thorough investigation suggests that the main reason lies in that they overlooked the impact of Multitripletsts, which are commonly seen in real-life large corpus 2. Let us consider the news flash sentence in FIG. 2. It can be seen that there are two relations associated with the entity Paris, i.e., (Donald Trump, Arrive in, Paris) and (Paris, Located in, France) in triplet form. Nevertheless, all the aforementioned models fail to capture them entirely. In particular, the model of (Zheng et al. 2017b) assumes that the entity Paris belongs to only one triplet, and hence, either of the two triplets would be concealed. The model of (Katiyar and Cardie 2017) finds relations between an entity and one entity preceding it, in which case either of the relation from Paris to Donald Trump or France would not be discovered. On the other hand, the models of (Miwa and Bansal 2016; Zheng et al. 2017a) presume that every entity pair has a relation. Under this scenario, abundant pairs should be thrown into other class, but the features of other are rather difficult to learn during RC training; hence, the noisy entities (Elysee Palace) and unintended relations between (Donald Trump, Elysee Palace) further confuse the classifier. Thus, target relations may not be correctly detected or chosen for Multi-tripletsts.

### THE PRESENT DISCLOSURE

In view of this, the object of the present invention is to propose a multi-triplets extraction method based on the entity relationship joint extraction model, which is used for effectively extracting multi-triplets in a sentence.

A multi-triplets extraction method based on the entity relationship joint extraction model provided by the present invention is characterized in that it comprises the following steps:

get the text, perform segmentation on the target text, and tag each word in the sentence;

establish a joint extraction model of entity relationships;

training the entity relationship joint extraction model;

the triple extraction is performed according to the entity relationship joint extraction model.

The tag each word in the sentence includes position, type and whether is involved with any relation or not of each word in the sentence. position part is used to describe the position of each word in the entity, type part associates words with type information of entities, relationship part refers to whether an entity in the sentence is involved in any relation.

The relationship extraction model includes an embedded layer for converting a word having a single semantic feature (1-hot) representation into an embedded vector, a bidirectional long-short-term memory Bi-LSTM layer for encoding an input sentence, and for decoding CRF layer.

Further, for any triplet t=(e₁, e₂, r)∈T, the embedding layer includes obtaining a header entity vector e₁ and a tail entity vector e₂ from the embedding layer. And the relation vector r, in order to better retain the relationship of the entity relationship, e₁+r≈e₂ is required, and the scoring function is:

f(t)=−∥e₁+r−e₂∥₂²;

Where T is a triple set, t is an arbitrary triple, e₁ is a head entity vector, e₂ is a tail entity vector, r is a relationship vector, and f(t) is a scoring function.

Further, the Bi-LSTM layer includes a forward LSTM layer and a reverse LSTM layer. To prevent deviation of the bidirectional LSTM output entity feature \vec{e₁}+r≈\vec{e₂} and [symbol] +r≈ [symbol] are required, and the scoring function is:

\vec{f}(t)=−∥\vec{e₁}+r−\vec{e₂}∥₂²;

[symbol]

(t)=−∥ [symbol] +r− [symbol] ∥₂²;

among them, \vec{f}(t) is the scoring function of the forward LSTM output, [symbol] (t) is the scoring function of the inverse LSTM output, \vec{e₁}, \vec{e₂} are the head entity vector and the tail entity vector of the forward LSTM output, respectively, and the head entity vector and the tail entity vector of the inverse LSTM output are respectively [symbol] , [symbol] .

Further, the training of the entity relationship joint extraction model includes establishing a loss function. When the loss function is smaller, the accuracy of the model is higher, and the model can better extract the triplet in the sentence, the loss function is:

L=Lₑ+λLᵣ;

Where L is the loss function, Lₑ is the entity extraction loss, Lᵣ is the relationship extraction loss, and λ is the weight hyperparameter.

Further, the entity extraction loss Lₑ takes the maximum value of the correct labeling probability p(y|X), and the entity extraction loss Lₑ is:

$${L}_{e} = log ( p ( y \vert X ) ) = f ( X , y ) - log ( {\sum }_{γ ∈ Y} {e}^{f ( X , \tilde{y} )} ) ;$$

The relationship extraction loss function is:

Lᵣ=Lₑₘ+\vec{Lₑₘ}+ [symbol] ;

Where X is the input sentence sequence; Y represents all sequences that X may generate; y refers to one of the predicted sequences; f(X,\tilde{y}) is the crf score; Lₑₘ is a boundary-based sorting loss function on the training set; \vec{Lₑₘ} is the forward LSTM loss function; [symbol] is the inverse LSTM loss function; \tilde{y} Refers to the predicted feature vector.

Further, the boundary-based ordering loss function on the training set is:

Lₑₘ=Σ_{t∈T} Σ_{t′∈T′}ReLu(f(t′)+γ−f(t))

The forward LSTM loss function is:

\vec{Lₑₘ}=Σ_{t∈T} Σ_{t′∈T′}ReLu(\vec{f}(t′)+γ−\vec{f}(t));

The inverse LSTM loss function is:

[symbol]

=Σ_{t∈T} Σ_{t′∈T′}ReLu( [symbol] (t′)+γ− [symbol] (t));

Where t is any triplet; T is a triple set; t′ is a negative triple; T′ is a negative triple set; f(t′) is a scoring function for the negative triplets; \vec{f}(t′) is a scoring function is the forward LSTM output of the negative triplet; [symbol] (t′) is a scoring function is the inverse LSTM output of the negative triplet; γ is a hyperparameter used to constrain the boundary between the positive and negative samples.

Further, the performing the triple extraction according to the entity relationship joint extraction model comprises:

The entity tag is predicted using the highest scored sequence of the following score functions:

$$\hat{y} = arg {max}_{\tilde{y} ∈ Y} f ( X , \tilde{y} ) ;$$

\hat{ε}={ê₁, . . . , êᵢ, . . . , êₘ} is a hypothetical set of entities that pass prediction, for pairs of candidate entities (êᵢ, êⱼ), generating an initial triple set \tilde{T}={(êᵢ, êⱼ, r)|r∈R}, initial triplet satisfies the function f_{c}(\tilde{t})=f(\tilde{t})+\vec{f}(\tilde{t})+ [symbol] (\tilde{t}), for each entity pair, when satisfied:

$$\hat{t} = arg {max}_{\tilde{t} ∈ \tilde{T}} {f}_{c} ( \tilde{t} ) ,$$

\hat{t} is the only triplet selected;

Where in is the number of candidate entities; ŷ refers to the entity prediction results for each word; \tilde{t} refers to the candidate triplets obtained based on the entity prediction results; \tilde{T} refers to a collection of candidate triplets.

The Multi-tripletst extraction method based on the entity relationship joint extraction model uses an additional relationship tager to describe the relationship feature, thereby allowing the negative sample strategy to strengthen the training of the model; the tri-part tagging scheme (Tri-part tagging scheme, TTS) of the design of the present invention in the process of relationship extraction, can exclude entities that are not related to the target relationship; in addition, the multi-triad extraction method based on the entity relationship joint extraction model can be used to extract more than three The tuple, and the model based on the triplet extraction method of the present invention, has a stronger multi-triplets extraction capability than other models.

### BRIEF DESCRIPTION OF THE DRAWINGS

FIG. 1 is a schematic flow chart of a multi-triplets extraction method based on an entity relationship joint extraction model according to an embodiment of the present invention;

FIG. 2 is an sample sentence with tri-part tagging;

FIG. 3 is a multi-layer embedding translation;

FIG. 4 is a diagram showing an example of a tri-part tagging scheme of the present invention;

FIG. 5 shows the performance of TME with varying λ.

### PREFERABLE EMBODIMENTS

The present invention will be further described in detail below with reference to the specific embodiments of the invention.

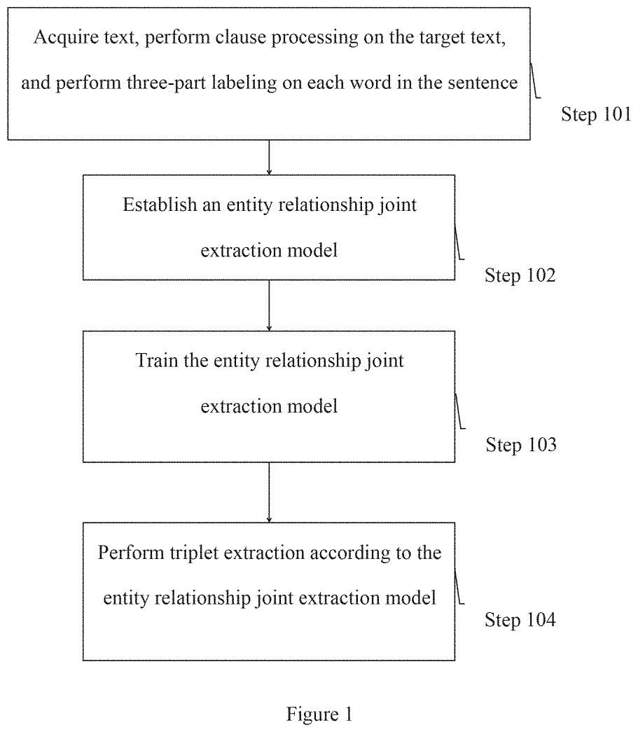

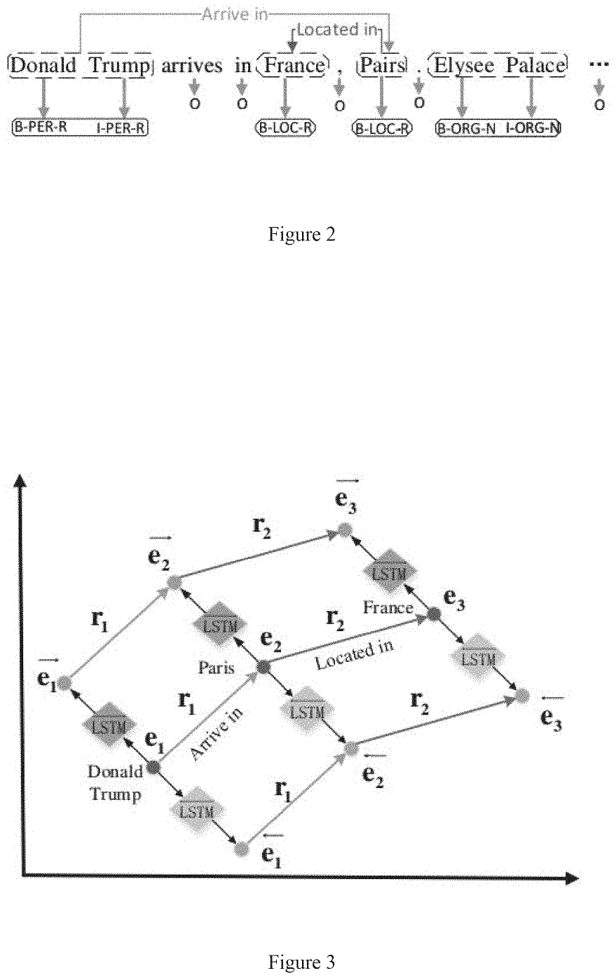

As shown in FIG. 1, an embodiment of the present invention is a schematic flowchart of a multi-triplets extraction method based on an entity relationship joint extraction model. The Multi-tripletst extraction method based on the entity relationship joint extraction model includes:

Step 101: Acquire text, perform clause processing on the target text, and perform tri-part labeling on each word in the sentence.

Tri-part tag for each word in a sentence includes tagging each word in a sentence in three parts: position, type and whether is involved with any relation or not; Position Part (PP) is used to describe the position of each word in the entity. For example, we use “BIO” to encode the position information of the words regarding an entity, “B” indicates that the word locates in the first place of an entity; “I” indicates it locates in a place after the first of an entity; and “0” indicates it locates in a non-entity place. Type Part (TP) associates words with type information of entities. For example, “PER”, “LOC” and “ORG” denote a person, a location, and an organization, respectively. Relationship Part (RP) refers to whether an entity in the sentence is involved in any relation, “R” indicates that the entity is involved in some relation(s) in the sentence; and “N” denotes that it does not participate in any target relation.

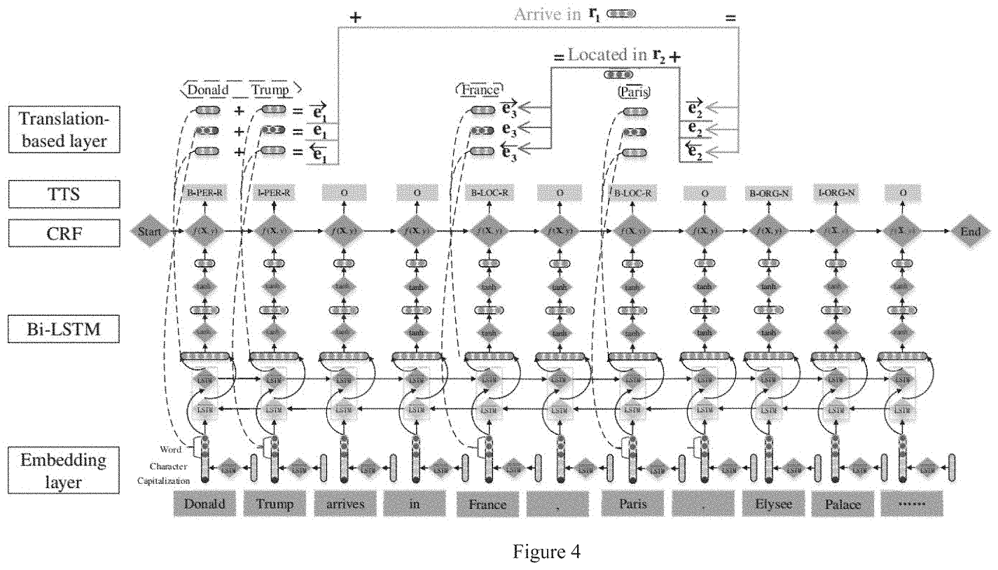

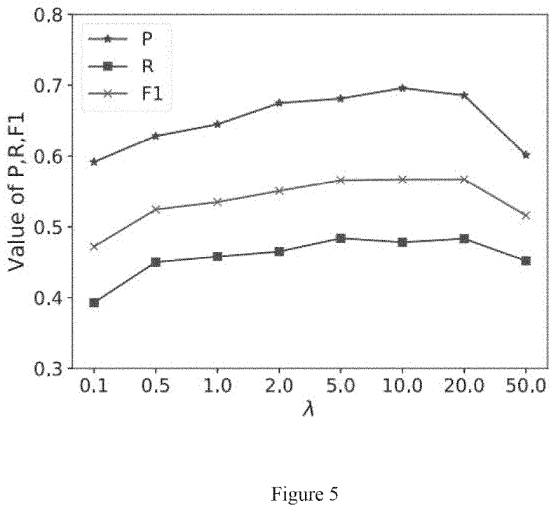

FIG. 4 shows an example of a sentence tag in a sample. The sentence contains four entities and two target relationships. Donald is the first word of the entity Donald Trump, its type is Person, and other the entity has a relationship, so Donald's TTS tag is “B-PER-R” and Trump's tag is “I-PER-R”.

Compared with the traditional BILOU labeling scheme (Li and Ji, 2014; Miwa and Bansal, 2016), the tagging scheme of the multi-triplets extraction method based on the entity relationship joint extraction model can clarify which are noise entities. A candidate entity pair can be generated without resorting to unrealistic constraints while avoiding excessively unrelated entities participating in the relationship extraction between each entity pair.

Step 102: Establish an entity relationship joint extraction model.

As shown in FIG. 3, an entity relationship joint extraction model of the present invention includes an embedding layer for converting a word having a 1-hot representation into an embedding vector, and a bidirectional long-and short-term memory Bi-LSTM layer for encoding an input sentence. And the CRF layer for decoding.

First, assume that for an input sentence sequence X, W=(w₁, w₂, . . . , wₛ) is a sequence of word vectors, \vec{H}=(\vec{h₁}, \vec{h₂}, . . . , \vec{h₂}) is the output of the forward LSTM, [symbol] =( [symbol] , . . . , [symbol] ) is the output of the reverse LSTM; T, E, and R represent the triple set, the entity set and the relation set, respectively; t represents a triple (e₁, e₂, r) ∈ T, were e₁, e₂ ∈ E and r ∈ R; for an entity in X e=(xᵢ, . . . , xᵢ₊ⱼ, . . . , xᵢ₊ₑ_{ₗ}) where i denotes the starting position in X, j denotes the jth word in the entity, and e₁ is the length of the entity. Use the position part in the entity to represent the entity tag and satisfy:

$$e = {{\sum }_{k = i}}^{i + {e}_{l}} {w}_{k} , \vec{e} = {\sum }_{k = i}^{i + {e}_{l}} \vec{{h}_{k}} , \overleftarrow{e} = {\sum }_{k = i}^{i + {e}_{l}} \overleftarrow{{h}_{k}}$$

Where e, \vec{e} with [symbol] physical features of the embedded layer and the Bi-LSTM layer, respectively.

Secondly, for any triplet t=(e₁, e₂, r) ∈ T, the head entity wants e₁ and the tail entity vector e₂ from the embedded layer, and then gets a match relationship vector r and require e₁ plus r to be equal to e₂, ie e₁+r≈e₂; then the scoring function is:

f(t)=−∥e₁+r−e₂∥₂²

Similarly, the entity vectors \vec{e₁}, \vec{e₂} and [symbol] , [symbol] are obtained from the forward and reverse LSTM respectively. To prevent the deviation of the solid features in the bidirectional LSTM, two additional constraints are required to be implemented: \vec{e₁}+r≈\vec{e₂} and [symbol] +r≈ [symbol] ; therefore, the score of the forward LSTM output the scoring functions of the function and the inverse LSTM output are:

\vec{f}(t)=−∥\vec{e₁}+r−\vec{e₂}∥₂²

[symbol]

(t)=−∥ [symbol] +r− [symbol] ₂²

Step 103: Train the entity relationship joint extraction model.

Training the entity relationship joint extraction model includes establishing the loss function. The loss function L consists of two parts, the entity extraction loss Le and the relationship extraction loss Lᵣ. When the loss function is smaller, the accuracy of the model is higher, and the model can be better. Extract the triplets in the sentence and the loss function is:

L=Lₑ+λLr

Where L is the loss function, Lₑ is the entity extraction loss, Lᵣ is the relationship extraction loss, and λ is the weight hyperparameter.

In the loss function of the entity extraction, take the maximum value of the probability p(y|X) of the correct label sequence, and the entity extraction loss function Lₑ is:

$${L}_{e} = log ( p ( y \vert X ) ) = f ( X , y ) - log ( {\sum }_{y ∈ Y} {e}^{f ( X , \tilde{y} )} )$$

The purpose of the entity extraction loss Lₑ is to encourage model to construct a correct tag sequence.

In the loss function of the relationship extraction, first establish a negative triple set T′. The negative triple set consists of the initial correct triple and the replaced relationship. For a triple (e₁, r, e₂), replace with any relationship r′ ∈ R The initial relationship r, the negative triple sample T′ can be described as:

T′={(e₁, e₂, r′)|r′∈R,r′≠r}.

In order to train the relationship vector and the excitation to distinguish the positive triplets from the negative triplets, the maximum value of the boundary-based sorting loss function on the training set is taken in the hidden layer:

Lₑₘ=Σ_{t∈T} Σ_{t′∈T′}ReLu(f(t′)+γ−f(t)),

Where γ>0 is a hyperparameter used to constrain the boundary between the positive and negative samples, ReLu=max(0, x) (Glorot et al., 2011). Similarly, the loss functions of the forward and reverse LSTMs can be described as follows:

\vec{Lₑₘ}=Σ_{t∈T} Σ_{t′∈T′}ReLu(\vec{f}(t′)+γ−\vec{f}(t))

[symbol]

=Σ_{t∈T} Σ_{t′∈T′}ReLu( [symbol] (t′)+γ− [symbol] (t))

Therefore, the relationship extraction loss function is as follows:

Lᵣ=Lₑₘ+\vec{Lₑₘ}+

[symbol]

Where X is the input sentence sequence; Y represents all sequences that X may generate; y refers to one of the predicted sequences; f(X,\tilde{y}) is the crf score; Lₑₘ is a boundary-based sorting loss function on the training set; \vec{Lₑₘ} is the forward LSTM loss function; [symbol] is the inverse LSTM loss function; \tilde{y} Refers to the predicted feature vector.

Step 104: Perform triplet extraction according to the entity relationship joint extraction model.

The triad extraction is performed according to the relational model, and the following score function is used, and the sequence with the highest score is used as the prediction sequence, and the score function is:

$$\hat{y} = arg {max}_{\tilde{y} ∈ \tilde{Y}} f ( X , \tilde{y} )$$

By using the predicted label, select the word labeled “r” as the candidate entity and put the results into a set. \hat{ε}={ê₁, . . . , êᵢ, . . . , êₘ} where in is the number of candidate entities; for pairs of candidate entities (êᵢ, êⱼ), generating an initial triple set \tilde{T}={(êᵢ, êⱼ, r)|r∈R} and satisfy the function f_{c}(\tilde{t})=f(\tilde{t})+\vec{f}(\tilde{t})+ [symbol] (\tilde{t}), for each entity pair, select only one triplet \hat{t} is to make:

$$\hat{t} = arg {max}_{\tilde{t} ∈ \tilde{T}} {f}_{c} ( \tilde{t} ) ,$$

This allows multiple triplets to be extracted for multiple entity pairs.

In addition, if f_{c}(\hat{t}) more than a relationship characteristic threshold δᵣ, then \hat{t} is a candidate triple, where the relationship feature threshold δᵣ is determined based on the accuracy (maximum) of the test set. Then, follow f_{c}(\hat{t}) collect all candidate triplets, the top n triplets with the highest score are considered to be extracted triplets, where n is a natural number greater than 1, which is used to compare with the target triplets in the test set; In each sentence, if and only if one of the extracted triplets perfectly matches the position and relationship of the entity, the triple is considered correct, and the correct triple is the final extracted triple.

Another embodiment of the present invention provides a comparison of the results of the extraction of the triplets by the model constructed by the present invention and other models.

The sample set selected for the comparison of the ternary extraction results by the different models of the present invention is NYT (Riedel et al., 2010) and NYT (2).

NYT contains articles from the 1987-2007 New York Times, which totals 235 k sentences. Invalid and repeated sentences have been filtered out, resulting in a 67 k sentence. In particular, the test set contains 395 sentences, most of which contain a triple.

NYT(2) is a dataset derived from NYT that is specially constructed for multi-triplets extraction. Take 1000 sentences from the NYT as a test set and use the rest as a training set. Unlike NYT, a larger proportion (39.1%) of the test set contains more than one triple.

Table 1 shows the data set statistics.

| Dataset | #Train | #Test | #Triplet | #Ent | #Rel |
|---|---|---|---|---|---|
| NYT | 235,983 | 395 | 17,663 | 67,148 | 24 |
| NYT(2) | 63,602 | 1,000 | 17,494 | 25,894 | 24 |

The triad extraction model of the present invention is recorded as TME, and the variant TME-RR of the triad extraction model of the present invention refers to model training using a random and stable relationship vector r, and TME-NS uses extra relation embeddings \vec{r} and [symbol] replace the the relation embeddings r in \vec{f}(t) and [symbol] (t); the comparison model is DS+logistic (Mintz et al., 2009), MultiR (Hoffmann et al., 2011), DS-Joint (Li and Ji, 2014), and FCM (Gormley et al. , 2015), LINE (Tang et al., 2015), CoType (Ren et al., 2017), and NTS-Joint (Zheng et al., 2017b). The present invention uses the accuracy (Prec), recall rate (Rec) and F value (F1) to evaluate the performance of each model.

For the parameter setting, the range of the dimension of the selected word vector d_{w} is {20, 50, 100, 200}, and the range of the character feature vector d_{ch.} is {5, 10, 15, 25}, The case of the uppercase and lowercase feature vector d_{c} is {1, 2, 5, 10}, and the range of the boundary γ of the positive and negative sample triplets is {1, 2, 5, 10}, and the weight is super The parameter λ has a value range of {0.2, 0.5, 1, 2, 5, 10, 20, 50}; the Dropout ratio is set from 0 to 0.5; the random gradient is reduced (Amari, 1993) to optimize the loss function. Take 10% of the sentences from the test set as a validation set, and the rest are used as evaluation sets. The most ideal parameters are λ=10.0, γ=2.0, d_{w}=100, d_{ch.}=25, d_{c}=5, Dropout=0.5.

Table 2 shows the experimental results of each model on NYT.

| Methods | Prec | Rec | F1 |
|---|---|---|---|
| FCM | 0.553 | 0.154 | 0.240 |
| DS + logistic | 0.258 | 0.393 | 0.311 |
| LINE | 0.335 | 0.329 | 0.332 |
| MultiR | 0.338 | 0.327 | 0.333 |
| DS-Joint | 0.574 | 0.256 | 0.354 |
| CoType | 0.423 | 0.511 | 0.463 |
| NTS-Joint | 0.615 | 0.414 | 0.495 |
| TME (Top-1)-Pretrain | 0.504 | 0.414 | 0.454 |
| TME (Top-1) | 0.583 | 0.485 | 0.530 |
| TME (Top-2) | 0.515 | 0.508 | 0.511 |
| TME (Top-3) | 0.458 | 0.522 | 0.489 |

Among them, TME (top-1) means that at most one triple is extracted from each sentence in the model, and TME (top-2) means that at most two triplets are extracted from each sentence in the model, TME (top-3)) indicates that up to three triplets are extracted from each sentence in the model. TME(top-1)-Pretrain indicates the result of the extraction when the vector is not pre-trained.

As can be seen from Table 2, TME (top-1) achieved excellent results compared to other models, with the F 1 value increasing to 0.530, which is better than the second place NTS-Joint by 7 percentage points; demonstrating that the present invention is based on sorting and migration. The model can more adaptively handle the relationship between pairs of entities.

Table 3 shows the experimental results of each model on NYT(2).

| Methods | Prec | Rec | F1 |
|---|---|---|---|
| CoType | 0.385 | 0.340 | 0.361 |
| MTS-Joint | 0.533 | 0.336 | 0.412 |
| TME-MR | 0.638 | 0.421 | 0.507 |
| TME-RR | 0.423 | 0.452 | 0.437 |
| TME-NS | 0.558 | 0.496 | 0.525 |
| TME (Top-1) | 0.749 | 0.436 | 0.551 |
| TME (Top-2) | 0.696 | 0.478 | 0.567 |
| TME (Top-3) | 0.631 | 0.500 | 0.558 |

As can be seen from Table 3, the F1 value of TME(top-2) increased to 0.567, which was 36.7% higher than that of NTS-Joint. TME (top-2) achieved the best on the NYT(2) sample set. As a result, it can be proved that its ability to process multi-triplets is superior to other models.

Another embodiment of the multi-triplets extraction method based on the entity relationship joint extraction model of the present invention analyzes the components of the tine model, and Table 4 shows the analysis results:

Table 4 shows the results of component analysis of the tine model of the present invention.

| | Top-1 | | | Top-2 | | | Top-3 | | |
|---|---|---|---|---|---|---|---|---|---|
| Model | Prec | Rec | F1 | Prec | Rec | F1 | Prec | Rec | F1 |
| TME | 0.749 | 0.436 | 0.551 | 0.696 | 0.478 | 0.567 | 0.631 | 0.500 | 0.558 |
| -TTS (-TP) | 0.741 | 0.436 | 0.549 | 0.680 | 0.478 | 0.561 | 0.610 | 0.498 | 0.548 |
| -TTS (-RP) | 0.610 | 0.376 | 0.465 | 0.488 | 0.484 | 0.486 | 0.400 | 0.547 | 0.462 |
| -TTS (-TP-RP) | 0.575 | 0.353 | 0.438 | 0.474 | 0.468 | 0.470 | 0.391 | 0.531 | 0.450 |
| -Character | 0.723 | 0.428 | 0.538 | 0.663 | 0.472 | 0.552 | 0.597 | 0.497 | 0.542 |
| -CRF | 0.690 | 0.414 | 0.517 | 0.608 | 0.470 | 0.530 | 0.522 | 0.495 | 0.509 |
| -\vec{f}- [symbol] | 0.552 | 0.310 | 0.398 | 0.521 | 0.368 | 0.431 | 0.468 | 0.399 | 0.431 |
| -f | 0.569 | 0.332 | 0.419 | 0.518 | 0.372 | 0.433 | 0.465 | 0.395 | 0.428 |
| -Dropout | 0.723 | 0.424 | 0.535 | 0.666 | 0.478 | 0.556 | 0.593 | 0.503 | 0.544 |
| -Pretrain | 0.686 | 0.411 | 0.514 | 0.613 | 0.466 | 0.530 | 0.539 | 0.495 | 0.516 |

In the table, tine is a model based on sorting and migration in the present invention, wherein -tts(-tp) refers to removing the type tag portion in the tri-part tag of the word, and -tts(-rp) refers to removing the tri-part tag in the word. The relationship tag part, -tts(-tp-rp), refers to the simultaneous removal of the type and relationship tag parts in the tri-part tag of the word.

It can be seen from Table 4 that in TME (top-2), after the introduction of the relationship tag, the precision of the triplet extraction is significantly improved, which is increased by 42.6%, but the recall rate is only decreased by 1.3%, indicating that the relationship tag is introduced in the model. It can effectively filter out entities that are not related to the target relationship.

Another embodiment of the multi-triplets extraction method based on the entity relationship joint extraction model of the present invention gives the influence of different weight hyperparameter λ values on the accuracy of the model; as shown in FIG. 4, if λ>20 or λ<5, the value of F1 decreases. When λ=10, TME strikes a balance between entity and relationship extraction, yielding an excellent F1 value.

Yet another embodiment of the present invention gives TME (Top-3) (representing a maximum of three triplets in each sentence in the model) for the entity and relationship extraction results in the sentence.

Table 5 is a case study of TME (Top-3) (where the bold entity represents the entity of the predicted existence relationship, the italic entity represents the predicted non-existent entity, and the bold triple represents the correct and predicted Come out of the triplets).

| Sentence I | . . . President Jacques Chirac_{[PER]} of France_{[LOC]} and Chancellor Angela Merkel_{[PER]} | | |
|---|---|---|---|
| | of Germany_{[LOC]} to press for agreement on a Security Council resolution demanding | | |
| | that Iran_{[LOC]} stop . . . | | |
| Correct | (Jacques Chirac, nationality, France) | Predicted | (Jacques Chirac, nationality, France) |
| | (Angela Merkel, nationality, Germany) | | (Angela Merkel, nationality, Germany) |
| | | | (Jacques Chirac, nationality, Germany) |
| Sentence II | . . . grasping the critical need for the United States_{[LOC]} to get Afghanistan_{[LOC]} right, she moved to | | |
| | Kandahar_{[LOC]} to help . . . Afghans for Civil Society, founded by the brother of Hamid Karzai_{[PER]} . . . | | |
| Correct | (Afghanistan, contains, Kandahar) | Predicted | (Kandahar, contains, Hamid Karzai) |
| | (Hamid Karzai, place_of_birth, Kandahar) | | (Afghanistan, contains, Kandahar) |
| | (Hamid Karzai, nationality, Afghanistan) | | (Hamid Karzai, nationality, Afghanistan) |
| Sentence III | . . . Across Iraq_{[LOC]}, from Mosul_{[LOC]} and Ramadi_{[LOC]} to Basra_{[LOC]} and Kirkuk_{[LOC]}, | | |
| | the lines of votes hummed with excitement, and with the hope that a permanent Iraqi government . . . | | |
| Correct | (Iraq, contains, Mosul) | Predicted | (Iraq, contains, Mosul) |
| | (Iraq, contains, Ramadi) | | (Iraq, contains, Basra) |
| | (Iraq, contains, Basra) | | (Iraq, contains, Ramadi) |
| | (Iraq, contains, Kirkuk) | | |

As can be seen from Table 5, tine can extract multi-triplets in each sentence, not only for the triplets in which each entity contains different relationships (sentence ii), but also for each sentence. A triple of a homogeneous relationship (sentence iii) between a plurality of different entity pairs is extracted.

In sentence I and sentence II, the unrelated entities Iran and United States prove that the three-tuple extraction model based on the tri-part labeling scheme of the present invention can effectively improve the performance of triple extraction in sentences.

In summary, the Multi-tripletst extraction method based on the entity relationship joint extraction model uses an additional relationship tag to describe the relationship feature, thereby allowing the negative sample strategy to strengthen the training of the model; The tri-part tagging scheme can exclude entities not related to the target relationship in the process of relationship extraction; in addition, the multi-triplets extraction method based on the entity relationship joint extraction model can be used to extract multi-triplets, and the model based on the triplet extraction method of the present invention has a stronger multi-triplets extraction capability than other models.

It should be understood by those of ordinary skill in the art that the discussion of any of the above embodiments is merely exemplary, and is not intended to suggest that the scope of the disclosure (including the claims) is limited to these examples; Combinations of the technical features in the different embodiments can also be combined, the steps can be carried out in any order, and there are many other variations of the various aspects of the invention as described above, which are not provided in detail for the sake of brevity.

All such alternatives, modifications, and variations are intended to be included within the scope of the appended claims. Therefore, any omissions, modifications, equivalents, improvements, etc., which are within the spirit and scope of the invention, are intended to be included within the scope of the invention.

1. A multi-triplets extraction method based on joint extraction model of entity relationship, comprising the following steps:
get the text, perform segmentation on the target text, and tag each word in the sentence;
establish a joint extraction model of entity relationships;
training the entity relationship joint extraction model;
the triple extraction is performed according to the entity relationship joint extraction model.

2. The multi-triplets extraction method according to claim 1, wherein the tag each word in the sentence includes tagging each word in a sentence in three parts: position, type and whether is involved with any relation or not, position part is used to describe the position of each word in the entity, type part associates words with type information of entities, relationship part refers to whether an entity in the sentence is involved in any relation.

3. The multi-triplets extraction method according to claim 2, wherein the entity relationship joint extraction model comprises an embedding layer for converting a word having a 1-hot representation into an embedding vector, for inputting the sentence encodes a bidirectional long-short-term memory Bi-LSTM layer and a CRF layer for decoding.

4. The multi-triplets extraction method according to claim 3, wherein for any triplet t=(e₁, e₂, r)∈ T, the embedded layer includes a slave the embedding layer obtains the header entity vector e₁, the tail entity vector e₂, and the relationship vector r, to better satisfy the migration, e₁+r≈e₂ is required, and the scoring function is:
f(t)=−∥e₁+r−e₂∥₂²;
where T is a triple set, t is an arbitrary triple, e₁ is a head entity vector, e₂ is a tail entity vector, r is a relationship vector, f(t) is a scoring function.

5. The multi-triplets extraction method according to claim 4, wherein the Bi-LSTM layer comprises a forward LSTM layer and a reverse LSTM layer, and in order to prevent deviation of the bidirectional LSTM output entity feature, \vec{e₁}+r≈\vec{e₂} and [symbol] +r≈ [symbol] , the scoring function is:
\vec{f}(t)=−∥\vec{e₁}+r−\vec{e₂}∥₂²; [symbol]
(t)=−∥ [symbol] +r− [symbol] ∥₂²;
among them, \vec{f}(t) is the scoring function of the forward LSTM output, [symbol] (t) is the scoring function of the inverse LSTM output, \vec{e₁}, \vec{e₂} are the head entity vector and the tail entity vector of the forward LSTM output, respectively, and the [symbol] , [symbol] are the header entity vector and the tail entity vector of the inverse LSTM output, respectively.

6. The multi-triplets extraction method according to claim 5, wherein the training of the entity relationship joint extraction model comprises establishing a loss function, and the smaller the loss function is, the higher the accuracy of the model is, the model can better extract the triplets in the sentence, the loss function is:
L=Lₑ+λLᵣ;
where L is the loss function, Lₑ is the entity extraction loss, Lᵣ is the relationship extraction loss, and λ is the weight hyperparameter.

7. The multi-triplets extraction method according to claim 6, wherein the entity extraction loss Lₑ takes a maximum value of a correct labeling probability p(y|X), and the entity extracts a loss Lₑ is:
$${L}_{e} = log ( p ( y \vert X ) ) = ( X , y ) - log ( {\sum }_{y ∈ Y} {e}^{f ( X , \tilde{y} )} ) ;$$
the relationship extraction loss function is: Lᵣ=Lₑₘ+\vec{Lₑₘ}+ [symbol] ;
where X is the input sentence sequence; Y represents all sequences that X may generate; y refers to one of the predicted sequences; f(X,\tilde{y}) is the crf score; Lₑₘ is a boundary-based sorting loss function on the training set; Lₑₘ is the forward LSTM loss function; [symbol] is the inverse LSTM loss function; \tilde{y} refers to the predicted feature vector.

8. The multi-triplets extraction method according to claim 7, wherein the boundary-based ordering loss function on the training set is:
Lₑₘ=Σ_{t∈T} Σ_{t′∈T′}ReLu(f(t′)+γ−f(t)),
the forward LSTM loss function is: \vec{Lₑₘ}=Σ_{t∈T} Σ_{t′∈T′}ReLu(\vec{f}(t′)+γ−\vec{f}(t));
the inverse LSTM loss function is: [symbol] =Σ_{t∈T} Σ_{t′∈T′}ReLu( [symbol] (t′)+γ− [symbol] (t));
where t is any triplet; T is a triple set; t′ is a negative triple; T′ is a negative triple set; f(t′) is a scoring function for the negative triplets; \vec{f}(t′) is a scoring function is the forward LSTM output of the negative triplet; [symbol] (t′) is a scoring function is the inverse LSTM output of the negative triplet; γ is a hyperparameter used to constrain the boundary between the positive and negative samples.

9. The multi-triplets extraction method according to claim 8, wherein the negative triple set is composed of an initial correct triplet and a replaced relationship, for a triplet (e₁, r, e₂), replace the initial relationship r with any one of the relations r′ ∈ R, then the negative sample T′ described as:
T′={(e₁, e₂, r′)|r′∈R, r″≠r}.

10. The multi-triplets extraction method according to claim 9, wherein the performing the triple extraction according to the entity relationship joint extraction model comprises:
the entity tag is predicted using the sequence of the highest score of the following score function:
$$\hat{y} = arg {max}_{\tilde{y} ∈ \tilde{Y}} f ( X , \tilde{y} ) ;$$
\hat{ε}={ê₁, . . . , êᵢ, . . . , êₘ} is a hypothetical set of entities that pass prediction, for pairs of candidate entities (êᵢ, êⱼ), generating an initial triple set \tilde{T}={(êᵢ, êⱼ, r)|r∈R}, the initial triplet satisfies the function f_{c}(\tilde{t})=f(\tilde{t})+\vec{f}(\tilde{t})+ [symbol] (\tilde{t}), for each entity pair, when satisfied:
$$\hat{t} = arg {max}_{\tilde{t} ∈ \tilde{T}} {f}_{c} ( \hat{t} ) ,$$
\hat{t}is the only triplet selected;
where in is the number of candidate entities; ŷ refers to the entity prediction results for each word; \tilde{t} refers to the candidate triplets obtained based on the entity prediction results; \tilde{T} refers to a collection of candidate triplets.

11. The multi-triplets extraction method according to claim 9, wherein the performing the triple extraction according to the entity relationship joint extraction model comprises:
the entity tag is predicted using the sequence of the highest score of the following score function:
$$\hat{y} = arg {max}_{\tilde{y} ∈ \tilde{Y}} f ( X , \tilde{y} ) ;$$
\hat{ε}={ê₁, . . . , êᵢ, . . . , êₘ} is a hypothetical set of entities that pass prediction, for pairs of candidate entities (êᵢ, êⱼ), generating an initial triple set \tilde{T}={(êᵢ, êⱼ, r)|r∈R}, the initial triplet satisfies the function f_{c}(\tilde{t})=f(\tilde{t})+\vec{f}(\tilde{t})+ [symbol] (\tilde{t}), for each entity pair, if f_{c}(\hat{t}) more than a relationship feature threshold δᵣ, then \hat{t} is a candidate triplet, where the relationship feature threshold δᵣ is determined according to the accuracy of the test set; all candidate triplets are collected, and the top n triplets with the highest score are considered to be extracted triplets, where n is a natural number greater than 1, comparing the extracted triplets to the target triplets in the test set, in each sentence, if and only if one extracted triplet and the position of the entity if the relationships match, then the extracted triplets are considered correct and the correct triplets are the final extracted triplets.

12. The multi-triplets extraction method according to claim 10, wherein in the model training process, the dimension of the selection word vector d_{w} ranges from {20, 50, 100, 200}, the character feature vector d_{ch,} has a value range of {5, 10, 15, 25}, and the upper and lower case feature vector d_{c} has a value range of {1, 2, 5, 10}, positive and negative examples, the range of the boundary γ of the triple is {1, 2, 5, 10}, and the range of the weight hyperparameter 2 is {0.2, 0.5, 1, 2, 5, 10, 20, 50}; the dropout ratio set from 0 to 0.5.

13. The multi-triplets extraction method according to claim 11, wherein in the model training process, the dimension of the selection word vector d, ranges from {20, 50, 100, 200}, the character feature vector d_{ch,} has a value range of {5, 10, 15, 25}, and the upper and lower case feature vector d_{c} has a value range of {1, 2, 5, 10}, positive and negative examples, the range of the boundary γ of the triple is {1, 2, 5, 10}, and the range of the weight hyperparameter λ is {0.2, 0.5, 1, 2, 5, 10, 20, 50}; the dropout ratio set from 0 to 0.5.
